(19) United States
(12) Patent Application Publication
(10) Pub. No.: US 2026/0120377 A1
(43) Pub. Date: Apr. 30, 2026

(54) ARTIFICIAL INTELLIGENCE BASED AUTO DUBBED LIP SYNCHRONIZATION GENERATION

(71) Applicant: LG ELECTRONICS INC., Seoul (KR)

(72) Inventors: Wooseong CHUNG, San Jose, CA (US); Hyunchul LEE, Mountain View, CA (US); Jacob SONG, Cupertino, CA (US); Sanghyun BYUN, San Jose, CA (US)

(73) Assignee: LG ELECTRONICS INC., Seoul (KR)

(21) Appl. No.: 19/368,987

(22) Filed: Oct. 24, 2025

Related U.S. Application Data
(60) Provisional application No. 63/711,659, filed on Oct. 24, 2024.

(51) Int. Cl. G06T 13/20; G06F 40/58; G06T 7/33; G06T 7/40; G06T 13/40; G06T 15/04; G06T 17/20; G10L 21/00

(52) U.S. Cl. CPC G06T 13/205; G06T 7/344; G06T 7/40; G06T 13/40; G06T 15/04; G06T 17/20; G10L 21/00; G06F 40/58; G06T 2207/30201; G06T 2210/22

(57) ABSTRACT

A display device for generating translated dubbed lip synchronizations in real time including a speaker diarization model to separate input audio into a background audio feed and an individual speaker audio feed, a face detection model to crop frames including a face; an active speaker detection model to pair the individual speaker audio feed to the cropped frames corresponding to an active speaker; a translation model to obtain translated speech audio, and a lip-synchronization model to generate lip-synchronized video frames comprising facial movements of the active speaker synchronized with the translated speech audio by utilizing a predictive model, and outputting the translated speech audio while displaying the lip-synchronized video frames based on the generated video frames in real time, wherein facial movements of the active speaker are synchronized with the translated speech audio being output.

### CROSS-REFERENCE TO RELATED APPLICATION

Pursuant to 35 U.S. C. § 119(e), this application claims the benefit of U.S. Provisional Ser. No. 63/711,659 , filed on Oct. 24, 2024, the contents of which are hereby incorporated by reference herein in its entirety.

### BACKGROUND

Many programs offered via streaming have very limited language choices, and TV broadcasts usually don't offer any language options. According to a 2019 study by the U.S. Census Bureau titled SELECTED SOCIAL CHARACTERISTICS IN THE UNITED STATES, (American Community Survey, ACS 5-Year Estimates Data Profiles), 68 million people—representing approximately 21.6% of the population—does not speak English at home, and 26 million people—representing approximately 8.2% of the population—state that they do not speak English “very well.”

This presents a dire need for multilingual options, however in many cases audio translation is not readily available. Further, when audio dubbing of content is offered, it is often poorly synchronized with the video aspect of the content, causing viewer discomfort.

Dubbing, the process of substituting an original vocal track in a video production with a supplementary audio track (often in a different language), is known in video media production. Historically, dubbing has required a manually intensive process involving human transcribers to create transcriptions of the original audio, human translators, and human voice actors to provide spoken recitations of the translations. This traditional approach is both time-consuming and extremely difficult to execute.

Recently, modern audio-video dubbing media production has increasingly employed artificial intelligence (AI) and machine learning systems. Existing AI methods synthesize audio media productions using synthetically generated audio content customized according to user-specified traits and characteristics. These systems typically involve training a neural network using collected data (text and audio from various speakers). These processes may generate synthesized audio media products by applying recorded instances of the speaker's voice characteristics or using pre-recorded synthetic audio produced by a trained instance of a learning engine. Methods currently exist for generating synthetic audio, transcription, translation, and synthesizing media wherein the speaker's facial movements are synchronized with the new audio. The techniques often involve capturing lip movement tracking data from the input video.

Despite advancements in AI-driven synthesis and translation, several shortcomings persist, for example, many programs offered via streaming services have very limited language choices, leading to a need for multilingual options where audio translation is not readily available. Also, even when automated dubbing services are offered, the resulting product is frequently poorly synchronized with the video, causing significant viewer discomfort. Further, existing audio-video dubbing solutions often focus primarily on generating high-quality video lip synchronization. However, these solutions fail to prioritize or efficiently handle real-time processing of a live video feed, such as a stream or broadcast. Processing video on a non-live media file differs significantly from processing a continuously streaming live feed.

To address these and other issues known to those of ordinary skill, embodiments of the present disclosure allow for programs to be accessible to more people by readily providing real time speech detection, dubbing, translation, and lip synchronization without negatively affecting the viewing experience while eliminating media type limitations and minimizing network performance dependency.

### SUMMARY

Accordingly, an object of the present disclosure is to address the above challenges by providing a method and system for generating artificial intelligence (AI) based auto dubbed lip synchronization for various content.

An implementation of the present disclosure includes a method for generating translated dubbed lip synchronizations at an edge device in real time based on streaming video content, where the method includes inputting audio of the video content to a speaker diarization model configured to separate the input audio into a background audio feed and an individual speaker audio feed comprising speech in a first language; inputting video of the video content to a face detection model configured to output one or more cropped frames including a face within the one or more cropped frames; inputting the individual speaker audio feed and the one or more cropped frames to an active speaker detection model configured to pair the individual speaker audio feed to the one or more cropped frames corresponding to an active speaker; obtaining translated speech audio corresponding to a translation of the individual speaker audio feed in a second language; inputting the translated speech audio and the paired individual speaker audio feed and the one or more cropped frames to a lip-synchronization model, wherein the lip-synchronization model is configured to encode the translated audio to attain a latent space representation and generate lip-synchronized video frames comprising facial movements of the active speaker synchronized with the translated speech audio by utilizing a predictive model; and displaying the lip-synchronized video frames based on the generated video frames in real time and outputting the translated speech audio, wherein facial movements of the active speaker are synchronized with the translated speech audio being output.

According to an implementation, the method may further include wherein the predictive model is configured to predict 3D mesh vertices for generating a mesh of a face of the active speaker, and the generating the lip-synchronized video frames comprises aligning the generated mesh with the one or more cropped frames by detecting mesh key points corresponding to the latent space representation of the encoded translated audio.

According to an implementation, the method may further include wherein the generating the lip-synchronized video frames further comprises extracting texture information of the face of the active speaker based on the one or more cropped frames, and rendering the lip-synchronized video frames based on the aligned generated mesh and the extracted texture information,

According to an implementation, the method may further include wherein the predictive model is configured to receive as input: a reference image of the active speaker, the one or more cropped frames having at least a mouth of the active speaker blurred by image noise, and a latent embedding corresponding to the translated speech audio; and perform a reverse diffusion based on the blurred one or more cropped frames to generate predictive frames comprising visual image information of at least the active speaker's mouth while speaking the translated speech audio.

According to an implementation, the method may further include wherein the active speech detection model is configured to perform convolutions on the individual speaker audio feed and the one or more cropped frames to generate one-dimensional temporal representations of the individual speaker audio feed and the one or more cropped frames, and input the one-dimensional temporal representations to a plurality of layers of gated recurrent units to match portions of the individual speaker audio feed to corresponding portions of the one or more cropped frames.

According to an implementation, the lip-synchronized video frames are generated at a frame rate that matches or exceeds a frame rate of the streaming video content.

According to an implementation, the method may further include wherein based on that the lip-synchronized video frames are generated at a frame rate that is less than a frame rate of the streaming video content by at least a threshold amount, the lip-synchronization model is instructed to skip generating video frames for one or more frames within the one or more cropped frames and generate the lip-synchronized video frames by calculating average values based on adjacent generated video frames for the skipped one or more frames.

Yet another implementation of the present disclosure includes a display device for generating translated dubbed lip synchronizations in real time based on streaming video content, the display device comprising: a display; one or more processors; and a memory storing instructions thereon, which when executed by the one or more processors causes the display device to: input audio of the video content to a speaker diarization model configured to separate the input audio into a background audio feed and an individual speaker audio feed comprising speech in a first language; input video of the video content to a face detection model configured to output one or more cropped frames including a face within the one or more cropped frames; input the individual speaker audio feed and the one or more cropped frames to an active speaker detection model configured to pair the individual speaker audio feed to the one or more cropped frames corresponding to an active speaker; obtain translated speech audio corresponding to a translation of the individual speaker audio feed in a second language; input the translated speech audio and the paired individual speaker audio feed and the one or more cropped frames to a lip-synchronization model, wherein the lip-synchronization model is configured to encode the translated audio to attain a latent space representation and generate lip-synchronized video frames comprising facial movements of the active speaker synchronized with the translated speech audio by utilizing a predictive model; and display via the display the lip-synchronized video frames based on the generated video frames in real time and output the translated speech audio, wherein facial movements of the active speaker are synchronized with the translated speech audio being output.

According to an implementation of the display device, the predictive model is configured to predict 3D mesh vertices for generating a mesh of a face of the active speaker, and the generating the lip-synchronized video frames comprises aligning the generated mesh with the one or more cropped frames by detecting mesh key points corresponding to the latent space representation of the encoded translated audio.

According to an implementation of the display device, the generating the lip-synchronized video frames further comprises extracting texture information of the face of the active speaker based on the one or more cropped frames, and rendering the lip-synchronized video frames based on the aligned generated mesh and the extracted texture information.

According to an implementation of the display device, the predictive model is configured to: receive as input: a reference image of the active speaker, the one or more cropped frames having at least a mouth of the active speaker blurred by image noise, and a latent embedding corresponding to the translated speech audio; and perform a reverse diffusion based on the blurred one or more cropped frames to generate predictive frames comprising visual image information of at least the active speaker's mouth while speaking the translated speech audio.

According to an implementation of the display device, the active speech detection model is configured to perform convolutions on the individual speaker audio feed and the one or more cropped frames to generate one-dimensional temporal representations of the individual speaker audio feed and the one or more cropped frames, and input the one-dimensional temporal representations to a plurality of layers of gated recurrent units to match portions of the individual speaker audio feed to corresponding portions of the one or more cropped frames.

According to an implementation of the display device, the lip-synchronized video frames are generated at a frame rate that matches or exceeds a frame rate of the streaming video content.

According to an implementation of the display device, based on that the lip-synchronized video frames are generated at a frame rate that is less than a frame rate of the streaming video content by at least a threshold amount, the lip-synchronization model is instructed to skip generating video frames for one or more frames within the one or more cropped frames and generate the lip-synchronized video frames by calculating average values based on adjacent generated video frames for the skipped one or more frames.

According to an implementation of the display device, the display device further comprises a transceiver, wherein the translated speech audio is obtained by transmitting via the transceiver the individual speaker audio feed to a speech-to-speech translation module with a selection of a second language and receiving the translated speech audio via the transceiver in the second language.

In accordance with some implementations, a computing or electronic device includes one or more processors, a non-transitory memory, and one or more programs; the one or more programs are stored in the non-transitory memory and configured to be executed by the one or more processors and the one or more programs include instructions for performing or causing performance of any of the methods described herein.

In accordance with some implementations, a non-transitory computer readable storage medium has stored therein instructions, which, when executed by one or more processors of an electronic device, cause the electronic device to perform or cause performance of any of the methods described herein. In accordance with some implementations, an electronic device includes: one or more processors, a non-transitory memory, and means for performing or causing performance of any of the methods described herein.

The present disclosure is not limited to what has been described above, and other aspects and advantages of the present disclosure not mentioned above will be understood through the following description of implementations of the present disclosure. Further, it will be understood that the aspects and advantages of the present disclosure may be achieved by the configurations described in claims and combinations thereof.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example an AI system in accordance with an embodiment of the present disclosure.

FIG. 2 is a block diagram of an example of a computing device in accordance with an embodiment of the present disclosure.

FIG. 3 is a block diagram of an example of an edge device in accordance with an embodiment of the present disclosure.

FIG. 4 is a block diagram of a neural network in accordance with an embodiment of the present disclosure.

FIG. 5 depicts a diagram showing an example of a system for generating translated lip-synchronizations according to an embodiment of the present disclosure.

FIG. 6 shows an example of an active speaker detection (ASD) model according to an embodiment of the present disclosure.

FIG. 7 shows an example of a speech-to-speech translation (ASR/AST) model according to an embodiment of the present disclosure.

FIG. 8 shows an example of a lip-synchronization model according to an embodiment of the present disclosure.

FIG. 9 shows an example of a diffusion based lip-synchronization prediction model according to an embodiment of the present disclosure.

FIG. 10 is an example of a method for compensating for resource constraints according to an embodiment of the present disclosure.

FIG. 11 is an example of a method of generating translated lip-synchronizations according to an embodiment of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Hereinafter, the implementations disclosed in the present specification will be described in detail with reference to the accompanying drawings, the same or similar elements regardless of a reference numeral are denoted by the same reference numeral, and a duplicate description thereof will be omitted. In the following description, the terms “module” and “unit” for referring to elements are assigned and used interchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. The accompanying drawings are used to help easily explain various technical features, and it should be understood that the implementations presented herein are not limited by the accompanying drawings. As such, the present disclosure should be construed to extend to any alterations, equivalents, and substitutes in addition to those which are particularly set out in the accompanying drawings.

The terminology used herein is used for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, implementations of the present disclosure will be described in detail with reference to the accompanying drawings. Like reference numerals designate like elements throughout the specification, and overlapping descriptions of the elements will not be provided.

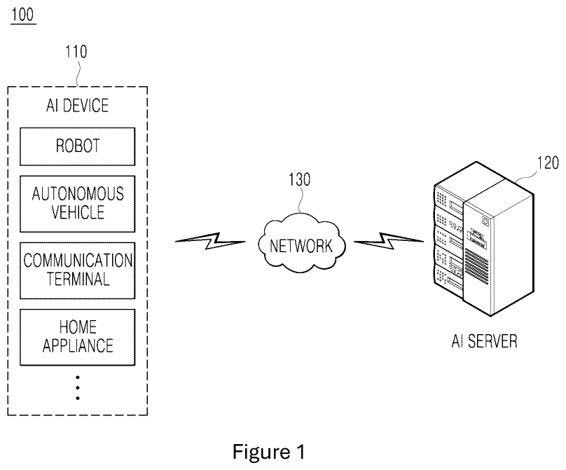

FIG. 1 is a view illustrating an example of an AI system including an AI device, an AI server, and a network connecting the above-mentioned components. While pertinent features are shown, those of ordinary skill in the art will appreciate from the present disclosure that various other features have not been illustrated for the sake of brevity and so as not to obscure more pertinent aspects of the example implementations disclosed herein.

Referring to FIG. 1, the AI device 100 may include an artificial intelligence based apparatus of the present disclosure and for example, include at least one of a robot, an autonomous vehicle, a communication terminal (for example, a mobile phone, a smart phone, or a tablet PC), an edge device, or a home appliance (for example, a television, washing machine, or robot cleaner).

Here, artificial intelligence refers to a field of studying artificial intelligence or a methodology to create the artificial intelligence and machine learning refers to a field of defining various problems treated in the artificial intelligence field and studying a methodology to solve the problems. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The ANN may include an input layer, an output layer, and may selectively include one or more hidden layers. Each layer includes one or more neurons, and the ANN may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an ANN is to determine a model parameter for significantly reducing a loss function. The loss function may be used as an indicator for determining an optimal model parameter in a learning process of an artificial neural network.

The machine learning may train an artificial neural network by supervised learning.

Supervised learning may refer to a method for training an artificial neural network with training data that has been given a label. In addition, the label may refer to a target answer (or a result value) to be guessed by the artificial neural network when the training data is inputted to the artificial neural network.

As a result, the artificial intelligence based object identifying apparatus trains the artificial neural network using a machine learning algorithm or requests a trained artificial neural network from the AI server 120 to receive the trained artificial neural network from the AI server 120. Further, when the image is received, the object identifying apparatus may estimate a type of the object in the received image using the trained artificial neural network.

When the AI server 120 receives the request for the trained artificial neural network from the AI device 110, the AI server 120 may train the artificial neural network using the machine learning algorithm and provide the trained artificial neural network to the AI device 110. The AI server 120 may be composed of a plurality of servers to perform distributed processing. In this case, the AI server 120 may be included as a configuration of a portion of the AI device 110, and may thus perform at least a portion of the AI processing together.

The network 130 may connect the AI device 110 and the AI server 120. The network 130 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 130 may also send and receive information using short distance communication and/or long distance communication. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The network 130 may include connection of network elements such as a hub, a bridge, a router, a switch, and a gateway. The network 130 can include one or more connected networks, for example, a multi-network environment, including a public network such as an internet and a private network such as a safe corporate private network. Access to the network 130 may be provided through one or more wire-based or wireless access networks. Furthermore, the network 130 may support the Internet of Things (IOT) network for exchanging and processing information between distributed elements such as things, 3G, 4G, Long Term Evolution (LTE), 5G communications, or the like.

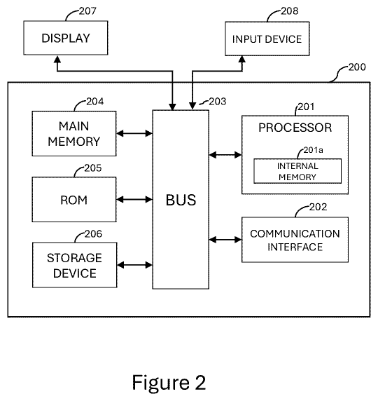

Referring now to FIG. 2, an illustration of an example device 200 is provided which may be used to embody, implement, execute, or perform embodiments of the present disclosure. With reference to FIG. 21, the term device may be referenced, however it will be understood by those of ordinary skill that device 200 may be implemented as, or be implemented as a part of, various other components and/or devices, including, but not limited to a robot, an autonomous vehicle, a communication or computational terminal (for example, a mobile phone, a smart phone, laptop or a tablet PC), an edge device, or a home appliance or device (for example, a television, washing machine, a refrigerator, or robot cleaner, or the like).

In selected embodiments, the device 200 may include a bus 203 (or multiple buses) or other communication mechanism, a processor 201, processor internal memory 201a, main memory 204, read only memory (ROM) 205, one or more additional storage devices 206, and/or a communication interface 202, or the like or sub-combinations thereof. The embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

A bus 203 or other communication mechanism, including multiple such buses or mechanisms, may support communication of information within the device 200. The processor 201 may be connected to the bus 203 and process information. In selected embodiments, the processor 201 may be a specialized or dedicated microprocessor configured to perform particular tasks in accordance with the features and aspects disclosed herein by executing machine-readable software code defining the particular tasks. In some embodiments, multiple processors 201 may be provided with each processing unit dedicated to a particular specialized task, such as graphics processing or artificial intelligence related processing.

Main memory 204 (e.g., random access memory-or RAM-or other dynamic storage device) may be connected to the bus 203 and store information and instructions to be executed by the processor 201. Processor 201 may also include internal memory 201a, such as CPU cache implemented by SRAM, for storing data used for executing instructions. Utilization of internal memory 201a may optimize data and memory management by reducing memory bandwidth usage with main memory 204. Although FIG. 2 depicts internal memory 201a as a component of processor 201, it will be understood that embodiments are included wherein internal memory 201a is a separate component apart from processor 201. Main memory 204 may also store temporary variables or other intermediate information during execution of such instructions.

ROM 205 or some other static storage device may be connected to a bus 203 and store static information and instructions for the processor 201. An additional storage device 206 (e.g., a magnetic disk, optical disk, memory card, or the like) may be connected to the bus 203. The main memory 204, ROM 205, and the additional storage device 206 may include a non-transitory computer-readable medium holding information, instructions, or some combination thereof, for example instructions that when executed by the processor 201, cause the device 200 to perform one or more operations of a method as described herein. A communication interface 202 may also be connected to the bus 203. A communication interface 202 may provide or support two-way data communication between a device 200 and one or more external devices (e.g., other devices contained within the computing environment).

In selected embodiments, the device 200 may be connected (e.g., via a bus) to a display 207. The display 207 may use any suitable mechanism to communicate information to a user of a device 200. For example, the display 207 may include or utilize a liquid crystal display (LCD), light emitting diode (LED) display, projector, or other display device to present information to a user of the computer 100 in a visual display. One or more input devices 208 (e.g., an alphanumeric keyboard, remote controller, mouse, microphone, stylus pen) may be connected to the bus 203 to communicate information and commands to the device 200. In selected embodiments, one input device 208 may provide or support control over the positioning of a cursor to allow for selection and execution of various objects, files, programs, and the like provided by the device 200 and displayed by the display 207.

The device 200 may be used to transmit, receive, decode, display, or the like one or more image or video files. In selected embodiments, such transmitting, receiving, decoding, and displaying may be in response to the processor 201 executing one or more sequences of one or more instructions contained in main memory 204. Such instructions may be read into main memory 204 from another non-transitory computer-readable medium (e.g., a storage device).

Execution of sequences of instructions contained in main memory 204 may cause the processor 201 to perform one or more of the procedures or steps described herein. In selected embodiments, one or more processors in a multi-processing arrangement may also be employed to execute sequences of instructions contained in main memory 204. Alternatively, or in addition thereto, firmware may be used in place of, or in connection with, software instructions to implement procedures or steps in accordance with the features and aspects disclosed herein. Thus, embodiments in accordance with the features and aspects disclosed herein may not be limited to any specific combination of hardware circuitry and software.

Non-transitory computer readable medium may refer to any medium that participates in holding instructions for execution by the processor 201, or that stores data for processing by a computer, and comprise all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, a communication interface 202 may provide or support external, two-way data communication to or via a network link. For example, a communication interface 202 may be a wireless network interface controller or a cellular radio providing a data communication network connection. Alternatively, a communication interface 202 may comprise a local area network (LAN) card providing a data communication connection to a compatible LAN. In any such embodiment, a communication interface 202 may send and receive electrical, electromagnetic, or optical signals conveying information.

A network link may provide data communication through one or more networks to other data devices (e.g., other devices such as 200, or terminals of various other types). For example, a network link may provide a connection through a local network of a host computer or to data equipment operated by an Internet Service Provider (ISP). An ISP may, in turn, provide data communication services through the Internet. Accordingly, a device 200 may send and receive commands, data, or combinations thereof, including program code, through one or more networks, a network link, and communication interface 202. Thus, the device 200 may interface or otherwise communicate with a remote server, or some combination thereof.

The various devices, modules, terminals, and the like discussed herein may be implemented on a computer by execution of software comprising machine instructions read from computer-readable medium, as discussed above. In certain embodiments, several hardware aspects may be implemented using a single computer, in other embodiments multiple computers, input/output systems and hardware may be used to implement the system.

For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

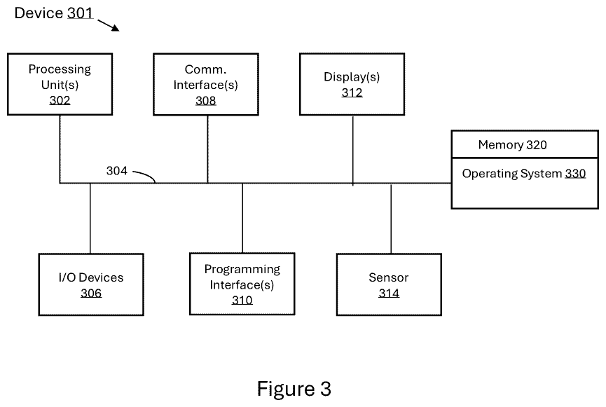

FIG. 3 is a block diagram of an example of a device 301, also referred to as an edge device, deployed device, target computing platform, or the like, in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein.

To that end, as a non-limiting example, in some implementations the edge device (in some cases implemented as the device 200 shown in FIG. 2) or the device 301 includes one or more processing units 302 (e.g., microprocessors, ASICs, FPGAs, GPUS, CPUs, processing cores, and/or the like), one or more I/O devices and sensors 306, one or more communications interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like, type interfaces), one or more programming (e.g., I/O) interfaces 310, one or more displays 312, one or more exterior image sensors 314, a memory 320, and one or more communication buses 304 for interconnecting these and various other components.

In some implementations, the one or more communication buses 304 include circuitry that interconnects and controls communications between system components.

In some implementations, the one or more displays 312 are capable of presenting content. In some implementations, the one or more displays 312 are also configured to present flat video content to the user (e.g., a 2-dimensional or “flat” audio video interleave (AVI), flash video (FLV), Windows Media Video (WMV), or the like file associated with a TV episode or a movie, or live video pass-through of the operating environments.

In some implementations, the one or more displays 312 correspond to holographic, digital light processing (DLP), liquid-crystal display (LCD), liquid-crystal on silicon (LCOS), organic light-emitting field-effect transitory (OLET), organic light-emitting diode (OLED), surface-conduction electron-emitter display (SED), field-emission display (FED), quantum-dot light-emitting diode (QD-LED), micro-electro mechanical systems (MEMS), and/or the like display types. In some implementations, the one or more displays 212 correspond to diffractive, reflective, polarized, holographic, etc. waveguide displays. For example, the device 301 includes a single display. In another example, the device 301 includes a display for each eye of the user.

In some implementations, the one or more exterior image sensors 314 are configured to obtain image data frames. For example, the one or more optional exterior-and/or interior-facing image sensors 314 correspond to one or more RGB cameras (e.g., with a complementary metal-oxide-semiconductor (CMOS) image sensor, or a charge-coupled device (CCD) image sensor), infrared (IR) image sensors, event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330. The optional operating system 330 includes procedures for handling various basic system services and for performing hardware dependent tasks.

FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

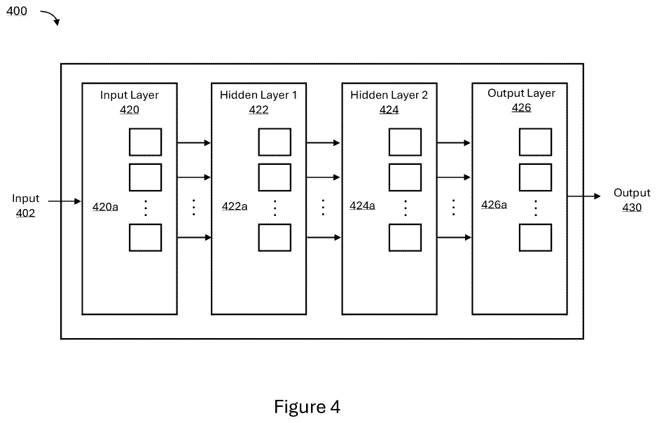

FIG. 4 is a block diagram of an example neural network 400 according to some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the neural network 400 includes an input layer 420, a first hidden layer 422, a second hidden layer 424, and an output layer 426. While the neural network 400 includes two hidden layers as an example, those of ordinary skill in the art will appreciate from the present disclosure that one or more additional hidden layers are also present in various implementations. Adding additional hidden layers adds to the computational complexity and memory demands but may improve performance for some applications.

In various implementations, the input layer 420 is coupled (e.g., configured) to receive various inputs 402 (e.g., image data). For example, the input layer 420 receives pixel data from one or more image sensors (e.g., the sensor 314 shown in FIG. 3). In various implementations, the input layer 420 includes a number of long short-term memory (LSTM) logic units 420a, which are also referred to as model(s) of neurons by those of ordinary skill in the art. In some such implementations, an input matrix from the features to the LSTM logic units 420a include rectangular matrices. For example, the size of this matrix is a function of the number of features included in the feature stream.

In some implementations, the first hidden layer 422 includes a number of LSTM logic units 422a. In some implementations, the number of LSTM logic units 422a ranges between approximately 10-500. Those of ordinary skill in the art will appreciate that, in such implementations, the number of LSTM logic units per layer is orders of magnitude smaller than previously known approaches (being of the order of O(101) to O(102)), which allows such implementations to be embedded in highly resource-constrained devices. As illustrated in the example of FIG. 4, the first hidden layer 422 receives its inputs from the input layer 420. For example, the first hidden layer 422 performs one or more of following: a convolutional operation, a nonlinearity operation, a normalization operation, a pooling operation, and/or the like.

In some implementations, the second hidden layer 424 includes a number of LSTM logic units 424a. In some implementations, the number of LSTM logic units 424a is the same as or similar to the number of LSTM logic units 420a in the input layer 420 or the number of LSTM logic units 422a in the first hidden layer 422. As illustrated in the example of FIG. 4, the second hidden layer 424 receives its inputs from the first hidden layer 422. Additionally and/or alternatively, in some implementations, the second hidden layer 424 receives its inputs from the input layer 420. For example, the second hidden layer 424 performs one or more of following: a convolutional operation, a nonlinearity operation, a normalization operation, a pooling operation, and/or the like.

In some implementations, the output layer 426 includes a number of LSTM logic units 426a. In some implementations, the number of LSTM logic units 426a is the same as or similar to the number of LSTM logic units 420a in the input layer 420, the number of LSTM logic units 422a in the first hidden layer 422, or the number of LSTM logic units 424a in the second hidden layer 424. In some implementations, the output layer 426 is a task-dependent layer that performs a computer vision related task such as feature extraction, object recognition, object detection, pose estimation, or the like. In some implementations, the output layer 426 includes an implementation of a multinomial logistic function (e.g., a soft-max function) that produces a number of outputs 430.

Neural networks, such as CNNs are often used to solve computer vision problems including feature extraction, object recognition, object detection, and pose estimation. A modern CNN is typically described as having an input layer, a number of hidden layers, and an output layer. In at least some scenarios, the input to the input layer of the CNN is an image frame while the output layer is a task-dependent layer. The hidden layers often include one of a plurality of operations such as convolutional, nonlinearity, normalization, and pooling operations. For example, a respective convolutional layer may include a set of filters whose weights are learned directly from data. Continuing with this example, the output of these filters are one or more feature maps that are obtained by applying filters to the input data of the convolutional layer.

Embodiments of the present disclosure follow which include device, system, and methods for generating AI based auto dubbed lip synchronizations for language translated video content. The embodiments include multi-modal TV systems leveraging multiple AI models operating primarily on an edge device for displaying video content, such as a television, laptop computer, tablet computer, and the like, to perform transcription, translation, and video lip synchronization. Some embodiments may be configured to process a live video feed such as an internet based stream or television broadcast in real-time without excessively compromising video dubbing quality.

In an example involving streaming video, embodiments of the disclosure may receive a streaming video input and perform processing of the stream by separating the audio into verbal and background components, dubbing the verbal audio, pairing the translated audio with the corresponding speaker in the scene, and synchronizing the speaker's facial movement accordingly. Embodiments may provide flexibility by performing processing on a frame-by-frame basis on a live-feed, eliminating media type limitations, and utilizing diarization for multi-speaker dubbing. Embodiments may be configured to perform computations on-device (i.e., at the device, such as TV or tablet), minimizing network performance dependency and maximizing internet resources allocated to downloading the video content itself.

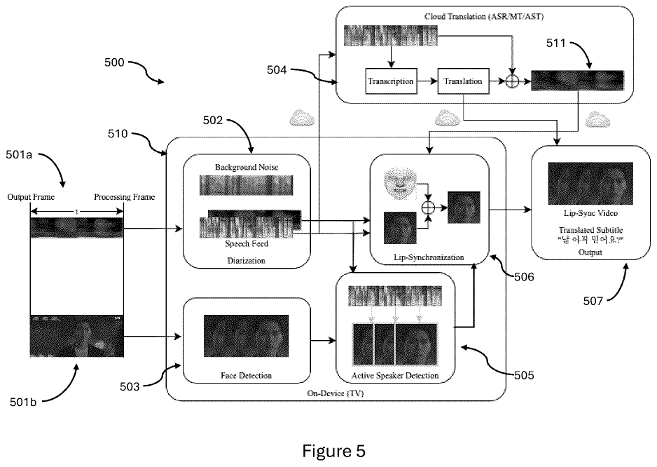

FIG. 5 shows an example of a system according to an embodiment of the present disclosure for generating AI based auto dubbed lip synchronizations.

The system 500 is designed to orchestrate multiple AI models in sequence, enabling efficient audio and video processing across diverse computational scenarios. The system requires a stable internet connection and a robust graphics processor (GPU) implemented in the device 510, to handle all models simultaneously. While this example, and the present disclosure, may refer to the device 510 as being implemented as a television, it will be understood by those of ordinary skill that various types of edge device implementations are considered, as discussed above.

The discussion may refer to various modules or models, including for example, a diarization model 502, a face detection model 503, speech-to-speech translation model 504, an active speaker detection (ASD) model 505, or the like. It will be understood by those of ordinary skill that the present disclosure considers embodiments in which the modules, or models as they may be referred, are implemented as software components, as well as embodiments in which they are implemented as one or more hardware elements, for example a processor, controller GPU, or the like, or as one or more non-transitory computer readable memory having instructions stored thereon for execution by a hardware element such as a processor, controller, GPU, or the like, for causing a device such as device 200 and components thereof to perform various operations described herein.

When receiving a video-audio stream 501 from sources such as cable or internet streaming, the system 500 may introduce a brief delay of a few seconds to account for processing time.

According to the embodiment, the pipeline starts by diarizing the input audio using a diarization model 502, isolating background noise from individual audio feeds corresponding to each detected speaker. Simultaneously, a face detection model 503 processes the video feed to extract and crop faces, focusing on frames where the lower half of the face is visible. The audio and video feeds are then synchronized using an active speaker detection (ASD) model 505, which pairs audio with the corresponding video. Each speaker's audio feed is sent to a cloud-based all-in-one speech-to-speech translation model 504. This model produces speech transcription (ASR), translated transcripts (MT), and translated speech audio (AST).

In the final step, each translated audio feed, matched with a speaker, undergoes lip synchronization 506. The system uses a mesh-based model 506 to predict facial mesh properties and blend them with the translated audio, generating novel video frames that align with the new audio. The TV then outputs the final product 507, which includes translated subtitles, translated audio, and lip-synced video.

The base system consists of 5 primary components, each running at faster-than-real-time inference to achieve real-time system, discussed in turn below.

Speaker diarization 502 separates the audio feed into background and speaker feeds. The diarization process begins with an audio feed, converted into a Mel Spectrogram, which is then separated into background and speaker components.

A lightweight speaker encoder model, utilizing convolution-augmented transformer layers-also known as conformer layers, may transform the audio into d-vectors that correspond to the detected number of speakers.

Depending on the number of speakers identified, different clustering methods may be employed. For example, Agglomerative Hierarchical Clustering (AHC) may be used if the number of speakers is below a predefined threshold. In other examples, spectral clustering may be applied for larger speaker counts. Additionally, minor speech segments may be filtered out as noise, based on a set threshold optimizing computational resource usage.

Accordingly, the speaker diarization 502 may output separated background and speaker feeds based on the input audio feed 501.

The face detection model 503 may crop parts of the frame containing detected faces. As all further processes may use face-cropped frames for ease of computation, the system includes a face detection layer 503 built on a chain of lightweight convolutions to output bounding boxes on faces that have the majority of their face visible within each output frame.

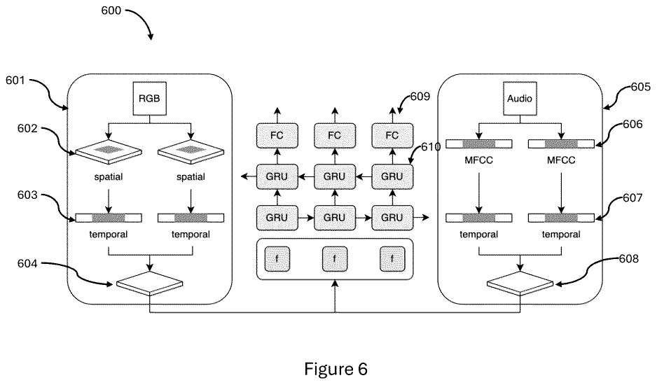

The active speaker detection (ASD) model 505 may be configured to match the diarized audio with frames output by the face detection model 503 having face cropping performed. In some embodiments, as shown in FIG. 6, to save resources, ASD 600 may match given audio and cropped frames in the shortest amount of time possible using a short chain of 3D convolutions 601 on a video frame sequence and 2D convolutions 605 on the audio sequence.

For example, for resource conservation, the 3D convolution may be converted into a sequence of 2D spatial 602, 606 and 1D temporal 603, 607 convolutions, and the 2D convolution may be converted into a sequence of 1D spatial 604 and 1D temporal 608 convolutions in order to match the video aspects to the temporal domain of the audio aspects.

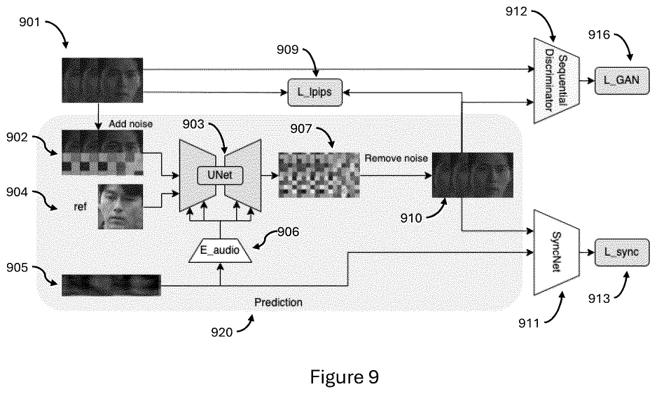

Based then on the 1D representations of both the video 604 and the audio 608 aspects, multiple layers of gated recurrent units (GRU) 610, for example two layers in the example of FIG. 9, in conjunction with the fully connected layer 906, may be used to make determinations on whether the 1D representations of the video frame and audio aspects are aligned correctly to determine whether the video frames correctly depict the active speaker that is speaking the speech audio. The ASD may thus output information on alignment between the video frames and the speech audio to provide a correlated data set of active speakers and their spoken audio.

Referring again to FIG. 5, the cloud-based speech-to-speech translation (ASR/AST) model 504 receives speech audio from the speaker diarization model 502 to generate translated text and audio. It is considered in the embodiments of the present disclosure that translation tasks require a high level of prior knowledge to be processed on-device at an edge device such as a television. However, it is also considered that with advancements in processing, data transmission/reception protocols, and data memory, certain embodiments may include a speech-to-speech translation (ASR/AST) model 504 implemented locally at the edge device 510. In the example of FIG. 6, the diarized speaker audios from the speaker diarization model 502 are transmitted to a cloud-based function, such as a server, which outputs translated text and audio.

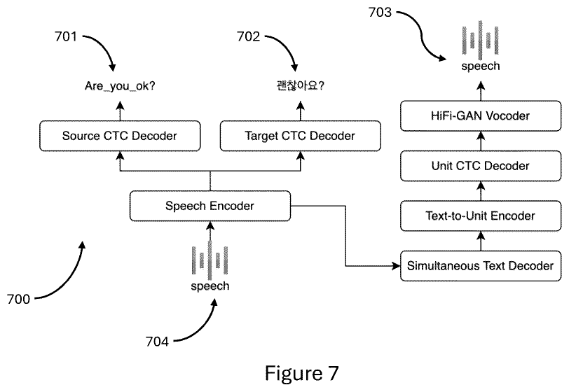

An example of a cloud-based speech-to-speech translation model is shown in FIG. 7, which is known to those of ordinary skill in the art. In the example of FIG. 7, a streaming audio encoder may use a conformer architecture, an iterative convolution, and a self-attention model for translating and transcribing original speech audio 704 to generate transcriptions 701, 702 in the source and target languages, as well as translated speech audio 703.

The encoded audio may be used for speech-to-text transcription and translation. Both translation and transcription may be performed on Connectionist Temporal Classification (CTC) decoder, with translation being processed auto-regressively. However, in case of falling accuracy on this lightweight decoder, a more robust solution such as GOOGLE Translate services may be used.

To generate audio from given sample audio and translated text, the cloud-based speech-to-speech translation (ASR/AST) model 504 employs Text-to-Unit (T2U) encoder along with CTC decoder, except this time non-autoregressive. It is processed through HiFi-GAN vocoder to output the final audio.

Referring again to FIG. 5, the Lip-Synchronization model 506 may predict mesh vertices for matching face-cropped frames with translated audio received from the speech-to-speech translation (ASR/AST) model 504. Given translated audio and matching face-cropped frames, it achieves audio-consistent lip-synchronization, producing novel video frames.

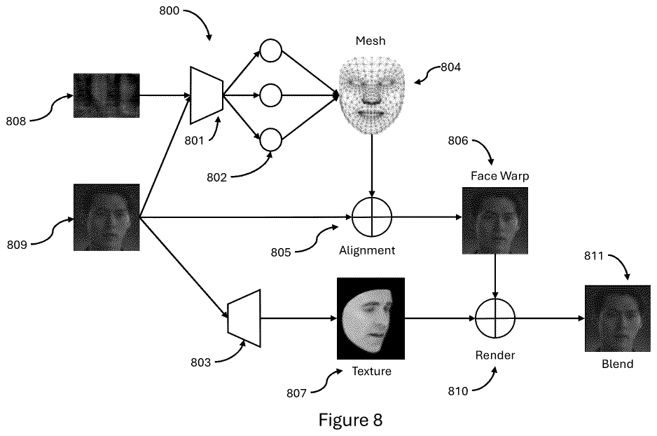

Referring to FIG. 8, an example of a lip-synchronization model 800 is depicted. In the example of FIG. 8, the lip-synchronization model 800 may receive translated speech audio 808 from the translation model, the original speech audio feed, and information from the active speaker detection model temporally matching the original speech audio feed, as well as the translated speech audio 808 with one or more frames of the active speaker.

The translated speech audio 808 from the translation (see 511 of FIG. 5) may be encoded through a VAE-like encoder (Variational Autoencoder) 801, attaining a latent space representation. This data may then be passed onto a fully-connected-layer 802 configured to predict coordinates of vertices generating a mesh representation 804 of the speaker's face while speaking the translated speech audio feed. Additionally, based on one or more cropped frames of the active speaker 809, a VAE-like decoder (Variational Autodecoder) 803 may predict the textures 807 corresponding to the active speaker's face.

The generated mesh 804 may then be aligned 805 with the one or more frames 809 in 3D, by detecting the mesh key points on the one or more frames and aligning/warping 805 the image accordingly. Then, the warped image 806 may be rendered 810 and blended with generated texture 807 to output the one or more frames as a final output video 811 having the active speaker's face synced with the translated audio feed.

In other embodiments, generating the output video having the one or more frames of the active speaker lip-synchronized with the translated speech audio feed may be accomplished using a diffusion-based lip-synchronization prediction model for generating lip-synchronized video output.

Referring to FIG. 9, the diffusion based lip-synchronization prediction model 902 may be configured to mask the lower half of the face of the active speaker in the one or more frames 901 by introducing pixelation, blur, noise, or other visual interference 902, and passing the resulting blurred one or more images through a diffusion model 903. In addition to the blurred images, the diffusion model 903 receive as input a reference image 904 of the active speaker's complete face obtained from the original video content, unrelated external content, or the one or more image frames of the active speaker themselves. Additionally, the diffusion model 903 may also receive as input a latent embedding obtained by encoding the translated speech audio 905 of the active speaker using an audio encoder, such as CLIP for example, where the latent embedding may be aligned with image embeddings corresponding to the blurred one or more images and the reference image in a shared semantic space.

Based on the latent embeddings of translated speech audio, the blurred one or more images, and the reference image of the active speaker, the diffusion model 903 may be configured to generate one or more frames 907 having predicted pixel information. With noise removed 907 from the generated one or more frames, the model may output one or more final frames 910 having generated visual image information representing the model's prediction of the active speaker's face and mouth while speaking the translated speech audio.

In the embodiment of FIG. 9, the lip-synchronization prediction model 920 may be supported by training components, including a SyncNet model configured to determine the audio synchronization between the final frames 910 and the translated speech audio 905 based on an audio sync loss function L_sync 913. Further, the final frames 910 may be compared using a model configured to determine relative similarity in visual appearance with the original frames of the content based on a perceptive similarity loss function L_Ipips 909. Lastly, a Sequential Discriminator model 912 may be implemented which is configured to detect a temporal consistency between the video aspect of the original one or more frames 901 and the final output frames 910 based on a generative adversarial network loss function L GAN 916.

Thus, in some embodiments, particularly wherein the hardware specifications of the edge device support computing requirements of a diffusion-based generative model to output final output frames 910 in real time based on an input streaming or broadcast content, the lip-synchronization prediction model 902 may be implemented instead of the mesh-based lip-synchronization model as discussed with respect to FIG. 8.

Based on the above examples, a multi-modal TV system may leverage multiple AI models running on an edge device such as a television, performing transcription, translation, and video lip synchronization. Taking in a video input, the system may separate audio into verbal audio and background audio, dub the verbal audio, pair it with a corresponding speaker in the scene, and sync the speaker's facial movement accordingly, readily providing a user with live transcription as well as translation without negatively affecting the viewing experience by preserving audio-video synchronization of facial movements.

In some embodiments, the system may also be adjusted based on various operational factors and conditions detected at the system and/or edge device. For example, there may be 4 different scenarios that may arise:

A: Normal Scenario: The system is ahead of the output stream by a specified threshold amount of time. The threshold may be determined in terms of time measurement of lip-synchronization generation relative to the input time of the video content, or other terms such as processing frames per second relative to the playback frames per second, or the like. In such scenario, it may be determined that there is ample computation resource reserve left to compensate for any contingency.

B: Low Resource Scenario: The system is ahead of the output stream by less than the threshold time limit. In such scenario, it may be determined that all computation resources are being utilized.

C: Extreme Limitation Scenario: The system is severely beyond the threshold time limit mentioned in Scenario B. The threshold time limit in this case may also be set to a different time limit than the one mentioned in Scenario B. It may be determined that there is not enough computation resource to handle all models in the pipeline.

D: Limited Internet Scenario: The internet bandwidth is insufficient to support a full speech-to-speech model I/O. Such scenario may apply concurrently with Scenario B or Scenario C.

Based on one or more of the above scenarios, embodiments of the present disclosure may implement various and corresponding adjustments to the process to ensure adequate performance while maintaining accuracy and usability.

Given Scenario A, in some embodiments, all systems will operate as discussed above with reference to FIG. 5, with diarization, ASD, Speech-to-Speech, and Lip-Synchronization.

Given Scenario B, in some embodiments, as Lip-Synchronization is the most resource-demanding model in the framework, the system may lower the frame-rate for mesh prediction, which may include skipping a few frames and instead averaging the mesh vertices positions for alignment.

Given Scenario C, in some embodiments, lowering the quality of Lip-Synchronization may not be implemented as an option in order to preserve usability and avoid viewer discomfort. Thus, embodiments of the system may entirely skip certain models to compensate for the scenario until the system is at least at the threshold time limit or more, or other specified amount of time, ahead of output again.

For determining skipping of models during Scenario C, the prioritization in some embodiments may be as follows:
1. Lip-Synchronization and Active Speaker Detection
2. Transcript Translation, Speech Translation, and Diarization
3. Audio Transcription

Given Scenario D, in some embodiments, compensation may depend on the severity of connectivity impairment. For example, according to an embodiment, the course of action and prioritization may be based directly on bandwidth, where an example of ordered courses of action are as follows in decreasing order of bandwidth:
1. Only receive speech translation audio feed, skipping both transcriptions;
2. Transcribe text on-device, send text feed for text-to-text translation only;
3. Generate translated audio feed on-device if resources allow;
4. Wait for a sentence to be completed before sending over the transcribed text, in a buffered manner.

In case internet impairments of Scenario D occur concurrently with Scenario B or C above, embodiments of the disclosure may always fallback and control operation according to Scenario C to avoid complications.

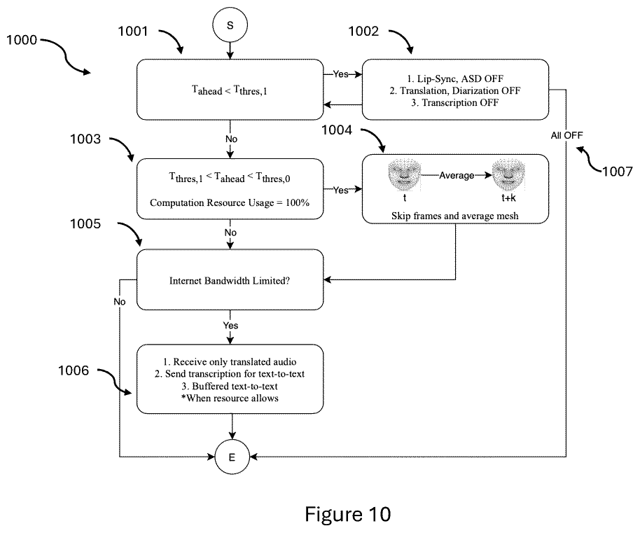

FIG. 10 is a flowchart showing an example method according to an embodiment of the present disclosure. At 1001, it is determined whether the system is ahead of the output stream by less than a threshold time limit T_{thres, 1}.

If the system is ahead of the output stream by more than the threshold time limit T_{thres, 1} (i.e., No at 1001), it is determined at 1003 whether the system is ahead of the output stream by less than a second threshold time limit T_{thres,0}. In such scenario, it may be determined that all computation resources are being utilized.

If the system is not ahead of the output stream by more than the first threshold time limit T_{thres, 1} (i.e., Yes at 1001), the system may entirely skip certain models to compensate until the system is at least at the threshold time limit or more, or other specified amount of time, ahead of output again 1002, 1007.

If the system is ahead of the output stream by more than the first threshold time limit T_{thres, 1} (i.e., No at 1001), and the system is ahead of the output stream by less than a second threshold time limit T_{thres, 0} (i.e., Yes at 1003), the system may lower the frame-rate for mesh prediction, which may include skipping a few frames and instead averaging the mesh vertices positions for alignment 1004.

If the system is ahead of the output stream by more than the first threshold time limit T_{thres, 1} (i.e., No at 1001), but the system is not ahead of the output stream by less than a second threshold time limit T_{thres, 0} (i.e., No at 1003), the system may compensate 1006 based on the severity of connectivity impairment, including: 1. only receiving speech translation audio feed (skipping transcriptions); 2. transcribing text at the edge device and sending the text feed to the translation model for text-to-text translation only; or 3. buffering text to text, for example, waiting for a sentence to be completed before sending the transcribed text to the translation model.

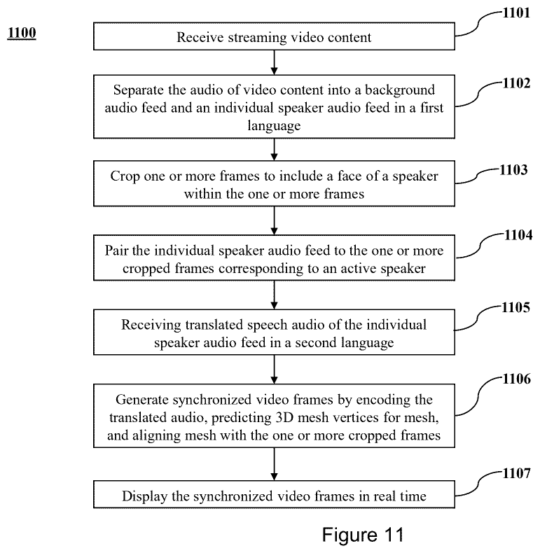

FIG. 11 is an example of a method 1100 of generating translated dubbed lip synchronizations at an edge device in real time based on streaming video content. The method may include receiving streaming video content 1101 through a streaming service, however various other embodiments are considered, including receiving content via over the air broadcast, local network casting, short range wireless communication content sharing, device to device content broadcast, or the like.

The method may include inputting audio of the input stream 1102 to a speaker diarization model configured to separate the input audio into a background audio feed and an individual speaker audio feed comprising speech in a first language.

The method may further include inputting video of the input stream 1103 to a face detection model configured to output one or more cropped frames including a face within the one or more frames.

The method may further include inputting the individual speaker audio feed and the one or more cropped frames to an active speaker detection model 1104 configured to pair the individual speaker audio feed to the one or more cropped frames corresponding to an active speaker.

The method may further include transmitting the individual speaker audio feed to a speech-to-speech translation module with a selection of a second language and receiving translated speech audio in the second language 1105.

The method may further include inputting the translated speech audio and the paired individual speaker audio feed and the one or more cropped frames to a lip-synchronization model 1106, wherein the lip-synchronization model is configured to encode the translated audio to attain a latent space representation, predict 3D mesh vertices for generating a mesh of a face of the active speaker, and align the generated mesh with the one or more cropped frames by detecting mesh key points to generate video frames synchronized with the translated speech audio.

The method may further include displaying the synchronized video frames 1107 based on the generated video frames in real time where facial movements of the active speaker are synchronized with the translated speech audio being output.

Implementations according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example implementations described above or by the use of such terms unless limited by the appended claims. Therefore, it should be understood that the scope of the present disclosure is not limited to the example implementations described above or by the use of such terms unless limited by the appended claims. Also, it should be apparent to those skilled in the art that various alterations, substitutions, and modifications may be made within the scope of the appended claims or equivalents thereof.

Therefore, technical ideas of the present disclosure are not limited to the above-mentioned implementations, be considered to fall within the scope of the present disclosure.

What is claimed is:

1. A method for generating translated dubbed lip synchronizations at an edge device in real time based on streaming video content, the method comprising:
inputting audio of the video content to a speaker diarization model configured to separate the input audio into a background audio feed and an individual speaker audio feed comprising speech in a first language;
inputting video of the video content to a face detection model configured to output one or more cropped frames including a face within the one or more cropped frames;
inputting the individual speaker audio feed and the one or more cropped frames to an active speaker detection model configured to pair the individual speaker audio feed to the one or more cropped frames corresponding to an active speaker;
obtaining translated speech audio corresponding to a translation of the individual speaker audio feed in a second language;
inputting the translated speech audio and the paired individual speaker audio feed and the one or more cropped frames to a lip-synchronization model,
wherein the lip-synchronization model is configured to encode the translated audio to attain a latent space representation and generate lip-synchronized video frames comprising facial movements of the active speaker synchronized with the translated speech audio by utilizing a predictive model; and
displaying the lip-synchronized video frames based on the generated video frames in real time and outputting the translated speech audio, wherein facial movements of the active speaker are synchronized with the translated speech audio being output.

2. The method of claim 1, wherein the predictive model is configured to predict 3D mesh vertices for generating a mesh of a face of the active speaker, and
the generating the lip-synchronized video frames comprises aligning the generated mesh with the one or more cropped frames by detecting mesh key points corresponding to the latent space representation of the encoded translated audio.

3. The method of claim 2, wherein the generating the lip-synchronized video frames further comprises extracting texture information of the face of the active speaker based on the one or more cropped frames, and rendering the lip-synchronized video frames based on the aligned generated mesh and the extracted texture information.

4. The method of claim 1, wherein the predictive model is configured to:
receive as input: a reference image of the active speaker, the one or more cropped frames having at least a mouth of the active speaker blurred by image noise, and a latent embedding corresponding to the translated speech audio; and
perform a reverse diffusion based on the blurred one or more cropped frames to generate predictive frames comprising visual image information of at least the active speaker's mouth while speaking the translated speech audio.

5. The method of claim 1, wherein the active speech detection model is configured to perform convolutions on the individual speaker audio feed and the one or more cropped frames to generate one-dimensional temporal representations of the individual speaker audio feed and the one or more cropped frames, and
input the one-dimensional temporal representations to a plurality of layers of gated recurrent units to match portions of the individual speaker audio feed to corresponding portions of the one or more cropped frames.

6. The method of claim 1, wherein the lip-synchronized video frames are generated at a frame rate that matches or exceeds a frame rate of the streaming video content.

7. The method of claim 1, wherein based on that the lip-synchronized video frames are generated at a frame rate that is less than a frame rate of the streaming video content by at least a threshold amount, the lip-synchronization model is instructed to skip generating video frames for one or more frames within the one or more cropped frames and generate the lip-synchronized video frames by calculating average values based on adjacent generated video frames for the skipped one or more frames.

8. The method of claim 1, wherein the translated speech audio is obtained by transmitting the individual speaker audio feed to a speech-to-speech translation module with a selection of a second language and receiving the translated speech audio in the second language.

9. A display device for generating translated dubbed lip synchronizations in real time based on streaming video content, the display device comprising:
a display;
one or more processors; and
a memory storing instructions thereon, which when executed by the one or more processors causes the display device to:
input audio of the video content to a speaker diarization model configured to separate the input audio into a background audio feed and an individual speaker audio feed comprising speech in a first language;
input video of the video content to a face detection model configured to output one or more cropped frames including a face within the one or more cropped frames;
input the individual speaker audio feed and the one or more cropped frames to an active speaker detection model configured to pair the individual speaker audio feed to the one or more cropped frames corresponding to an active speaker;
obtain translated speech audio corresponding to a translation of the individual speaker audio feed in a second language;
input the translated speech audio and the paired individual speaker audio feed and the one or more cropped frames to a lip-synchronization model,
wherein the lip-synchronization model is configured to encode the translated audio to attain a latent space representation and generate lip-synchronized video frames comprising facial movements of the active speaker synchronized with the translated speech audio by utilizing a predictive model; and
display via the display the lip-synchronized video frames based on the generated video frames in real time and output the translated speech audio, wherein facial movements of the active speaker are synchronized with the translated speech audio being output.

10. The display device of claim 9, wherein the predictive model is configured to predict 3D mesh vertices for generating a mesh of a face of the active speaker, and the generating the lip-synchronized video frames comprises aligning the generated mesh with the one or more cropped frames by detecting mesh key points corresponding to the latent space representation of the encoded translated audio.

11. The display device of claim 10, wherein the generating the lip-synchronized video frames further comprises extracting texture information of the face of the active speaker based on the one or more cropped frames, and rendering the lip-synchronized video frames based on the aligned generated mesh and the extracted texture information.

12. The display device of claim 9, wherein the predictive model is configured to:
receive as input: a reference image of the active speaker, the one or more cropped frames having at least a mouth of the active speaker blurred by image noise, and a latent embedding corresponding to the translated speech audio; and
perform a reverse diffusion based on the blurred one or more cropped frames to generate predictive frames comprising visual image information of at least the active speaker's mouth while speaking the translated speech audio.

13. The display device of claim 9, wherein the active speech detection model is configured to perform convolutions on the individual speaker audio feed and the one or more cropped frames to generate one-dimensional temporal representations of the individual speaker audio feed and the one or more cropped frames, and
input the one-dimensional temporal representations to a plurality of layers of gated recurrent units to match portions of the individual speaker audio feed to corresponding portions of the one or more cropped frames.

14. The display device of claim 9, wherein the lip-synchronized video frames are generated at a frame rate that matches or exceeds a frame rate of the streaming video content.

15. The display device of claim 9, wherein based on that the lip-synchronized video frames are generated at a frame rate that is less than a frame rate of the streaming video content by at least a threshold amount, the lip-synchronization model is instructed to skip generating video frames for one or more frames within the one or more cropped frames and generate the lip-synchronized video frames by calculating average values based on adjacent generated video frames for the skipped one or more frames.

16. The display device of claim 9, further comprising a transceiver, wherein the translated speech audio is obtained by transmitting via the transceiver the individual speaker audio feed to a speech-to-speech translation module with a selection of a second language and receiving the translated speech audio via the transceiver in the second language.

17. A non-transitory computer-readable medium storing instructions that, when executed by one or more processors of an electronic device, causes the electronic device to:
input audio of the video content to a speaker diarization model configured to separate the input audio into a background audio feed and an individual speaker audio feed comprising speech in a first language;
input video of the video content to a face detection model configured to output one or more cropped frames including a face within the one or more cropped frames;
input the individual speaker audio feed and the one or more cropped frames to an active speaker detection model configured to pair the individual speaker audio feed to the one or more cropped frames corresponding to an active speaker;
transmit via a transceiver the individual speaker audio feed to a speech-to-speech translation module with a selection of a second language and receiving the translated speech audio in the second language via the transceiver;
input the translated speech audio and the paired individual speaker audio feed and the one or more cropped frames to a lip-synchronization model,
wherein the lip-synchronization model is configured to encode the translated audio to attain a latent space representation and generate lip-synchronized video frames comprising facial movements of the active speaker synchronized with the translated speech audio by utilizing a predictive model; and
display via a display the lip-synchronized video frames based on the generated video frames in real time and output the translated speech audio, wherein facial movements of the active speaker are synchronized with the translated speech audio being output.

18. The non-transitory computer-readable medium of claim 17, wherein the predictive model is configured to predict 3D mesh vertices for generating a mesh of a face of the active speaker,
wherein the generating the lip-synchronized video frames comprises aligning the generated mesh with the one or more cropped frames by detecting mesh key points corresponding to the latent space representation of the encoded translated audio,
wherein the generating the lip-synchronized video frames further comprises extracting texture information of the face of the active speaker based on the one or more cropped frames, and rendering the lip-synchronized video frames based on the aligned generated mesh and the extracted texture information.

19. The non-transitory computer-readable medium of claim 17, wherein:
wherein the predictive model is configured to receive as input: a reference image of the active speaker, the one or more cropped frames having at least a mouth of the active speaker blurred by image noise, and a latent embedding corresponding to the translated speech audio, and perform a reverse diffusion based on the blurred one or more cropped frames to generate predictive frames comprising visual image information of at least the active speaker's mouth while speaking the translated speech audio, and
wherein the active speech detection model is configured to perform convolutions on the individual speaker audio feed and the one or more cropped frames to generate one-dimensional temporal representations of the individual speaker audio feed and the one or more cropped frames, and input the one-dimensional temporal representations to a plurality of layers of gated recurrent units to match portions of the individual speaker audio feed to corresponding portions of the one or more cropped frames.

20. The non-transitory computer-readable medium of claim 17, wherein the lip-synchronized video frames are generated at a frame rate that matches or exceeds a frame rate of the streaming video content.
